(19) United States
(12) Patent Application Publication
(10) Pub. No.: US 2010/0089329 A1
(43) Pub. Date: Apr. 15, 2010

(54) Selective Pet Feeding System

(76) Inventor: Peter Lefferson, Saint Petersburg, FL (US)

Correspondence Address: PETER LEFFERSON, 6101 7 AVE. N., ST. PETERSBURG, FL, 33710-7015, US

(21) Appl. No.: 12/250,833

(22) Filed: Oct. 14, 2008

(51) Int. Cl. A01K 15/04

(52) U.S. Cl. 119/51.02

(57) ABSTRACT

A selective pet feeding system comprising a gas or air blowing device that discourages a pet that should not eat at that station by gently blowing a stream of gas or air at the face of said pet. The pets are identified through the commonly understood technology of Radio Frequency Identification (RFID) and where a RFID fob attached to their body programmed with a code that is read by the selective feeding station.

### BACKGROUND OF THE INVENTION

1. Field of the Invention

This invention relates to selective feeding of pets and farm animals.

Heading

2. Prior Art

It is common for families to own several pets. These might be a variety of cats and dogs or there might be similar pets of a different age. It is also common for these pets to receive feed appropriate for the animal type or age. A veterinarian will often prescribe a special diet for one particular pet in the household.

To solve this problem of selective feeding pets might be fed in different rooms. They might be caged with their special diet at feeding time. One might be fed outside and another one inside the house. One might use a food dispensing device that will open only for a specific pet.

A device that solves this problem should follow common humane design rules for pet ownership.

a. The device must not harm the pet with chemicals, loud sounds, or electrical shock.

b. The device should not confuse the pet by spreading its message from one feeding station to the adjacent stations.

c. The device should not harm the environment with noise or chemicals.

d. The device should not allow food that was not consumed by the selected pet to be eaten by another pet.

e. The device should allow the pet owner to feed from any feeding dish that works well for the pet and for dish sanitation.

In 1996 Targa (U.S. Pat. No. 5,570,655) invented a pet dish that had audio speakers attached to it. They would be silent when the correct pet came to the dish but would produce a loud discouraging sound when an undesired pet came close. The Targa invention counters the above design criterion because it generates a loud sound in the surrounding environment and that it would confuse other pets that might be in the vicinity of the offending pet.

The following reference patents have one thing in common. They all use some form of Radio Frequency Identification (RFID) of well known technology, to identify a pet or farm animal. This technology is now widely used in stores and warehouses to automatically identify and control the processing of manufactured goods. They all use a collar attached RFID programmed identification module, often called a fob, that is read by a programmed identification module code reader in order to identify the animal by a radio link between the fob and the fob reading device.

Back in 1977 Lee (U.S. Pat. No. 4,036,178) invented a device that dispensed food into the pet dish for only the pets who wore a special coded fob attached to the collar that was electrically recognized by said invention. In 1978 Rodrian (U.S. Pat. No. 4,129,855) invented much the same thing but specifically for farm animals. In 1984 Meister and Winkle (U.S. Pat. No. 4,463,706) came up with the same idea but for dispensing medicine to farm animals. In 1985 Kuzara (U.S. Pat. No. 4,532,892) invented another feed dispensing system for farm animals that also used the collar attached radio signal sensing fob. In 2000 Matsuura (U.S. Pat. No. 6,044,795) invented a pet food dispensing system that used an RFID tag that was surgically implanted in the pet. All of these counter the above design criterion by leaving uneaten food for another pet to eat.

In 1997 Lanfranchi (U.S. Pat. No. 5,669,328) improved on this concept by using RFID to open a pet feeding dish only for the accepted pet. Again in 2002 Lewis (U.S. Pat. No. 6,349,671) invented a pet feeding device using the same ideas. In 2006 Clarke (U.S. Pat. No. 7,124,707) came up with another selective pet food dispenser based on the RFID link. In 2007 Turner (U.S. Pat. No. 7,228,816) teaches us about of more technical looking device of the same idea. In 1998 Roybal (U.S. Pat. No. 5,826,538) essentially invented the same thing for field animals. These also are counter to the above criterion because it requires a feeding dish specifically designed for the opening device.

The objective of the present invention is to provide a pet feeding system that meets all of the above design objectives with none of the aforementioned objections.

### SUMMARY

In accordance with the present invention, a selective pet feeding system comprises a gas or air blowing device that discourages a pet that should not eat at that station by gently blowing a stream of gas or air at the face of said pet. The pets are identified through the commonly understood technology of Radio Frequency Identification (RFID) and wear a RFID fob attached to their collar programmed with a code that is read by the selective feeding station.

### DRAWINGS—FIGURES

FIG. 1 illustrates the problem of feeding the correct food to the correct pet.

FIG. 2 expands on this problem showing multiple pets and one having air blown in his face because he went to the wrong feed station.

FIG. 3 shows a closer view of that situation where the pet is wearing the RFID fob attached to his collar.

FIG. 4 shows one embodiment of this invention where the pet selection box contains a motor driven fan that is blowing air through the box.

FIG. 5 shows one embodiment of the fan driven air mover controlled by the RFID control circuits that sense a code from the pet's RFID fob through the RFID antenna.

FIG. 6 is as above except the air moving method is now compressed gas stored in a compressed gas supply bottle and controlled by a gas valve.

FIG. 7 shows one of many identification methods for the pet. The pet must be given some way to identify his feeding station.

FIG. 8 shows the pet selection device with a means to constrain the feed dish within the range of the RFID code sensing system.

FIG. 9 shows the pet selection device with a means to direct the pet to feed from the front and it shows a antenna coil inside a ferrite pot core as a means to direct the antenna field up and so not interfere with another pet selection device that may be close by.

### DRAWINGS—REFERENCE NUMERALS

10 dog

12 food for dog

14 cat

16 food for cat

20 pet selection device

21 pet selection device in alarm state

22 output gas hole

24 blowing gas

26 rejected pet

28 pet food for another pet

30 RFID fob

32 fob attachment means

40 gas blowing fan

42 input gas hole

44 fan motor

46 motor drive shaft

50 RFID control circuits

52 RFID antenna

54 plug in power supply

56 power supply wire

60 compressed gas supply bottle

62 gas feed line

64 gas valve

66 gas outlet port

70 means for pet to identify their food dish

80 means to constrain

82 feed dish

90 ferrite half pot core

92 RFID antenna coil

94 means to guide the pet

### DRAWINGS—DETAILED DESCRIPTION

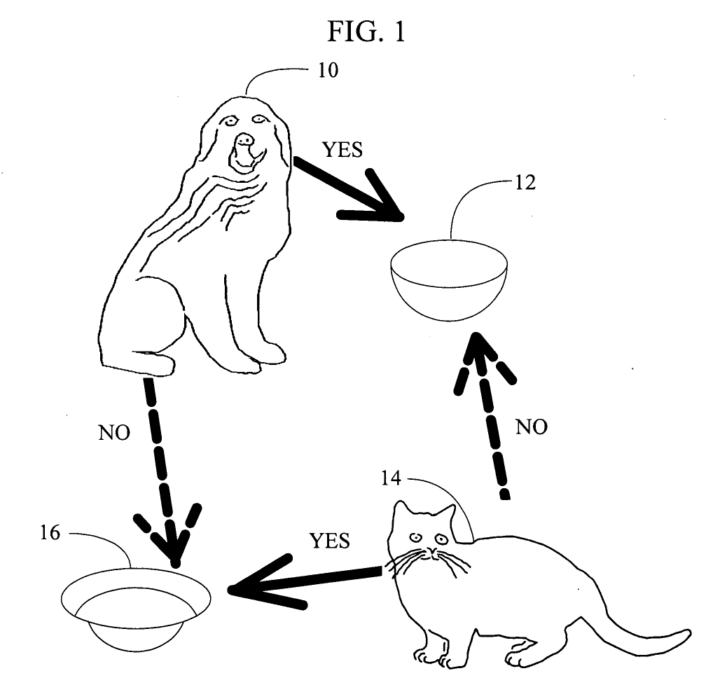

FIG. 1 illustrates the basic problem solved by this invention. Dog 10 should eat food for dog 12 but not food for cat 16. Cat 14 should eat food for cat 16 and not food for dog 12. This problem should be solved without harming the pets, disturbing the environment with noise, confusing the pets, and allowing pet feeding dishes to be appropriate for the pet and for sanitation.

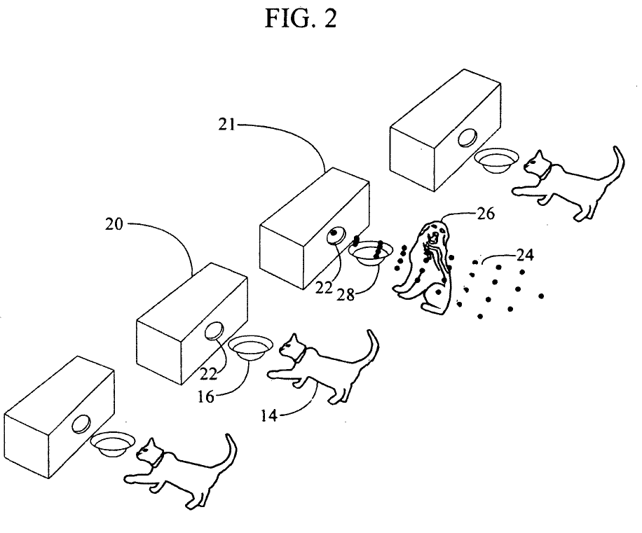

FIG. 2 illustrates a solution to this problem for multiple pets. Pet selection device in alarm state 21 has learned that rejected pet 26 has approached the pet food for another pet 28. It has responded by blowing air 24 through its output gas hole 22 at the face of rejected pet 26. On the other hand, pet selection device 20 has recognized cat 14 and will allow cat 14 to eat food for cat 16 and not blow air in the face of cat 14.

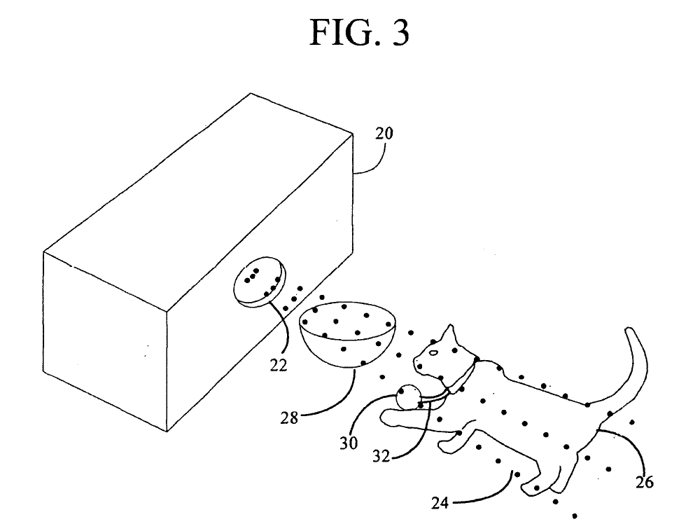

FIG. 3 shows more clearly the rejected cat 26 and the blowing gas 24 in his face coming from the output gas hole 22 from the pet selection device 20. He is not to eat pet food for another pet 28. FIG. 3 also show the RFID fob 30 that is attached to his collar through fob attachment means 32. The pet selection device 20 has read the code that is stored in the RFID fob 30, checked its memory, and learned that rejected pet 26 is not to feed at this station.

The pet selection device 20 and the fob 30 for the essential parts of a Radio Frequency Identification (RFID), of well known technology, now widely used in stores and warehouses to automatically identify and control the processing of manufactured goods. The fob 30 is a collar attached RFID programmed identification module that is read by a programmed identification module code reader in the selection device 20 in order to identify the animal by a radio link between the fob and the selection device 20.

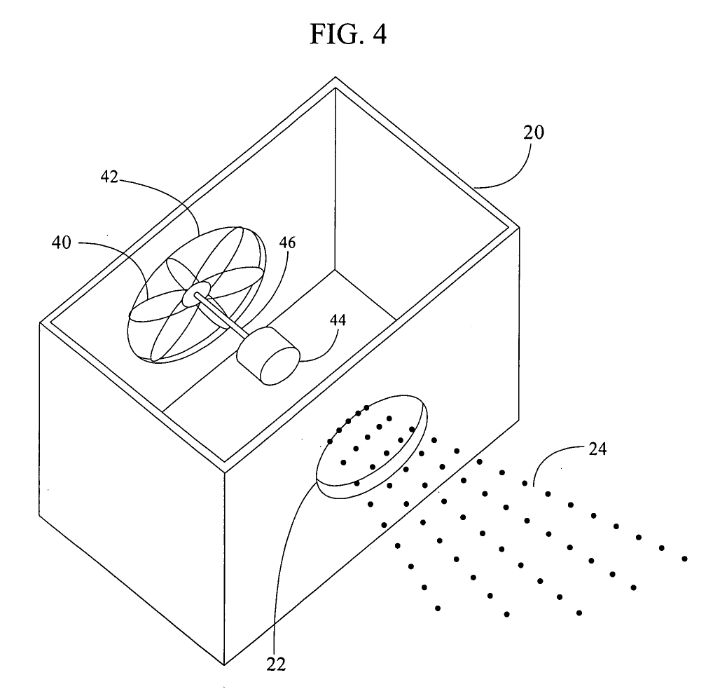

FIG. 4 looks inside the pet selection device 20 and illustrates one embodiment where gas blowing fan 40 is pulling air through the input gas hole 42 and out the output gas hole 22. The fan is driven by fan motor 44 through motor drive shaft 46.

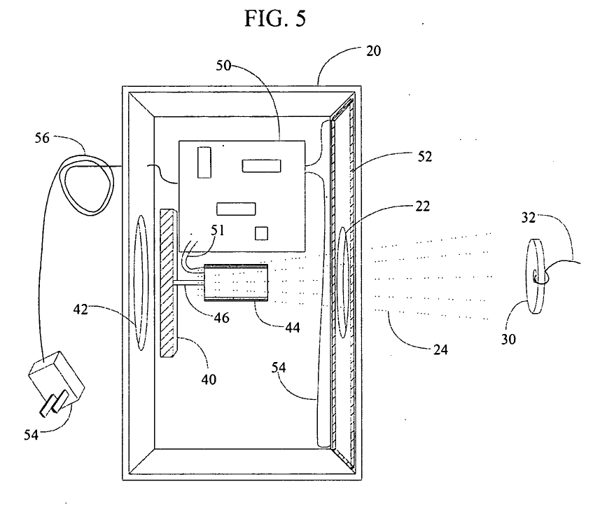

FIG. 5 shows one embodiment of the pet selection device 20 where the fan motor 44 is driven from the RFID control circuits 50. RFID control circuits 50 send a radio frequency signal to RFID antenna 52 using standard known methods in RFID industry. This radio signal is sensed by the RFID fob 30 which responds by returning a code to the RFID antenna 52 and RFID control circuits 50. The RFID control circuits 50 contains a memory of known codes as per known RFID design methods in the RFID industry. It decides if the pet wearing the RFID fob 30 is accepted or rejected at this feeding station. If rejected, RFID control circuits 50 will turn on fan motor 44 and drive gas blowing fan 40 to push a blowing gas 24 at the face of the rejected pet.

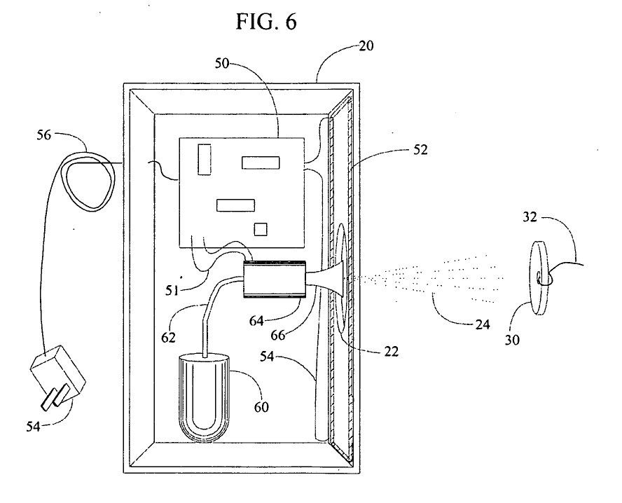

FIG. 6 replaces the gas blowing fan 40 of FIG. 5 with a compressed gas supply bottle 60. The compressed gas is carried through the gas feed line 62 to the gas valve 64 and then through the output hole 22 and into the face of a rejected pet. This gas valve 64 is driven from the RFIC control circuits 50 through the RFID antenna 52 and the RFID fob 30

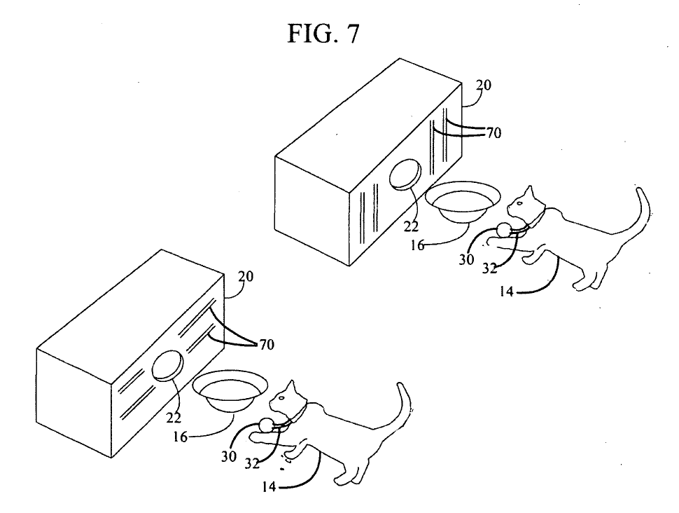

FIG. 7 illustrates one solution to a problem the pets may have. For a family with multiple pets, how would each pet identify their feeding station? Many pets are color blind. FIG. 7 shows each pet selection device 20 with a means for pet to identify their food dish 70 attached to the pet selection device 20.

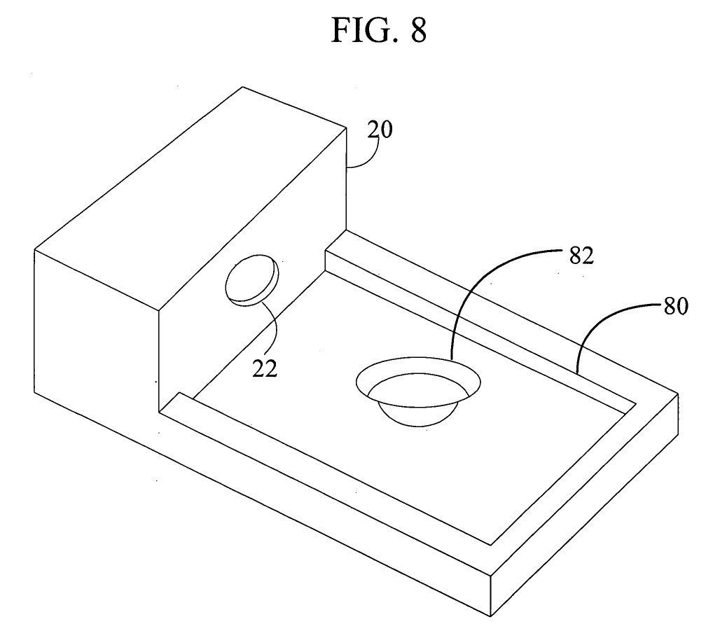

FIG. 8 shows the pet selection device 20 with a means to constrain 80 the feed dish 82 within the range of the RFID code sensing system.

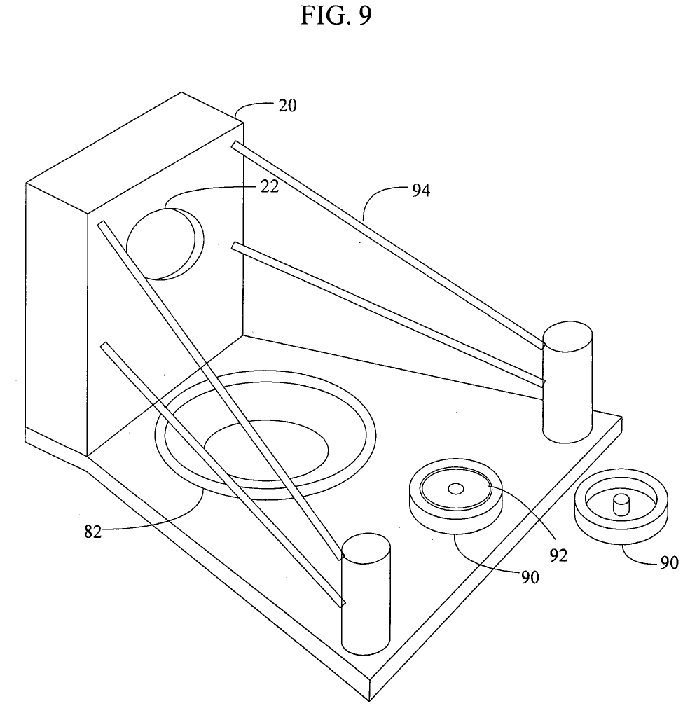

FIG. 9 shows the pet selection device 20 with a means to guide the pet 94 so it feeds from the front of the pet selection device 20. It also shows a standard ferrite half pot core 90. Ferrite half pot cores 90 are usually used in pairs to form the magnetic core of electrical pulse transformers. They are known for limited magnetic field outside of the core as compared to an electrical transformer with no core at all. FIG. 9 also shows the RFID antenna coil 92 inside the ferrite half pot core 90. This construction directs the field of the RFID antenna coil 92 up toward the RFID fob 30 that hangs from the neck of the pet as it feeds from feed dish 82.

Accordingly, the reader will see that the design objectives sighted in the prior art section above have been met. This method of blowing a soft stream of gas in the face of a pet to discourage his feeding from a dish put down for another pet is not harmful to the pet, it does not blast his ears with sound, give an electrical shock, or harm him with a discouraging chemical. This method will not confuse the pet because stream of gas is directed only to the pet in front of the pet selection device. The method will not disturb the environment with a loud sound. It will not allow food that was left over from the selected pet to be eaten by another pet. It will allow the pet owner to feed the pet from any feeding dish that works well for the pet and for dish sanitation.

Although the description above contains many specificities, these should not be construed as limiting the scope of the invention but as merely providing illustration of some of the presently preferred embodiments of this invention.

1. (canceled)

2. (canceled)

3. (canceled)

4. (canceled)

5. (canceled)

6. A selective animal feeding system for the feeding of specific animals with special dietary requirements living in a common environment with a plurality of other animals comprising:
a. a plurality of pet selection device feeding stations,
b. each containing there in a radio frequency identification (RFID) code reader programmed to specifically identify an animal wearing an RFID fob programmed with the same identifying code,
c. with each pet selection device containing a means to blow gas at an animal not wearing an RFID fob programmed to that specific RFID code reader to discourage this animal from feeding at that pet selection device feeding station,
d. with a means to guide the pet toward the feed dish and bring the RFID fob sufficiently close to the RFID antenna coil to be read by the RFID code reader.
